(19) United States
(12) Patent Application Publication
(10) Pub. No.: US 2015/0362944 A1
(43) Pub. Date: Dec. 17, 2015

(54) SYSTEMS AND METHODS FOR CABLE RESISTANCE COMPENSATION

(71) Applicant: QUALCOMM Incorporated, San Diego, CA (US)

(72) Inventors: Christian Sporck, Campbell, CA (US); Shadi Hawawini, Mountain View, CA (US); Thomas O'Brien, Powell, OH (US)

(21) Appl. No.: 14/303,883

(22) Filed: Jun. 13, 2014

(51) Int. Cl. G05F 5/00

(52) U.S. Cl. CPC G05F 5/00

(57) ABSTRACT

The present disclosure includes circuits and methods for cable resistance compensation. In one embodiment, the present disclosure includes a circuit comprising a regulator coupled to receive an input voltage and an input current from an external power source across a cable, a voltage sensor coupled to sense the input voltage, a collapse detector coupled to detect whether or not the input voltage is below a first value, and a current limit circuit to control a maximum current in the regulator. The current limit circuit is reconfigured to a plurality of current limit values and the collapse detector detects if the input voltage from the external power source collapses below the first value at the plurality of current limit values. The voltage sensor measures different voltages at different input currents, and in accordance therewith, reduces collapse voltage value to compensate for a voltage drop caused by a resistance of the cable.

### BACKGROUND

The present disclosure relates to circuits and methods for cable resistance compensation.

Power is typically routed between electronic devices using different types of cables. As electric current flows through a cable, intrinsic resistance of the cable may cause voltage drops between different terminals of the cable. The voltage drop for high quality cables may be less than the voltage drop for low quality cables.

One common use of a cable is to charge an electronic device's battery. In this application, a wall adapter receives AC voltage from a wall outlet and coverts the AC voltage to a DC voltage. Current and voltage from the wall adapter (also referred to as a dedicated charge port or “DCP”) may be coupled through a cable to an electronic device, such as a cellular phone, to provide power to the device and/or charge the device's battery.

One problem associated with coupling power through a cable to an electronic device is that different types of cables may result in different voltages being available at inputs of the electronic device circuitry. As current flows through a low quality cable, the voltage provided at the output of the wall adapter may drop significantly due to cable resistance by the time it reaches the input of the electronic device. Yet, for high quality cables, there may be little resistive drop. Accordingly, some sensitive device circuitry may not operate properly due to voltage variations caused by different cable resistances.

### SUMMARY

The present disclosure includes circuits and methods for cable resistance compensation. In one embodiment, the present disclosure includes a circuit comprising a regulator coupled to receive an input voltage and an input current from an external power source across a cable, a voltage sensor coupled to sense the input voltage, a collapse detector coupled to detect whether or not the input voltage is below a first value, and a current limit circuit to control a maximum current in the regulator. The current limit circuit is reconfigured to a plurality of current limit values and the collapse detector detects if the input voltage from the external power source collapses below the first value at the plurality of current limit values. The voltage sensor measures different voltages at different input currents, and in accordance therewith, reduces collapse voltage value to compensate for a voltage drop caused by a resistance of the cable.

The following detailed description and accompanying drawings provide a better understanding of the nature and advantages of the present disclosure.

### BRIEF DESCRIPTION OF THE DRAWINGS

FIG. 1 illustrates a cable resistance compensation circuit according to one embodiment.

FIG. 2 illustrates a cable resistance compensation circuit according to another embodiment.

FIG. 3 illustrates a process of compensating for cable resistance according to an embodiment.

FIG. 4 illustrates compensation of cable resistance according to another embodiment.

FIG. 5 illustrates another example of cable resistance compensation according to another embodiment.

### DETAILED DESCRIPTION

The present disclosure pertains to compensating for cable resistance. In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

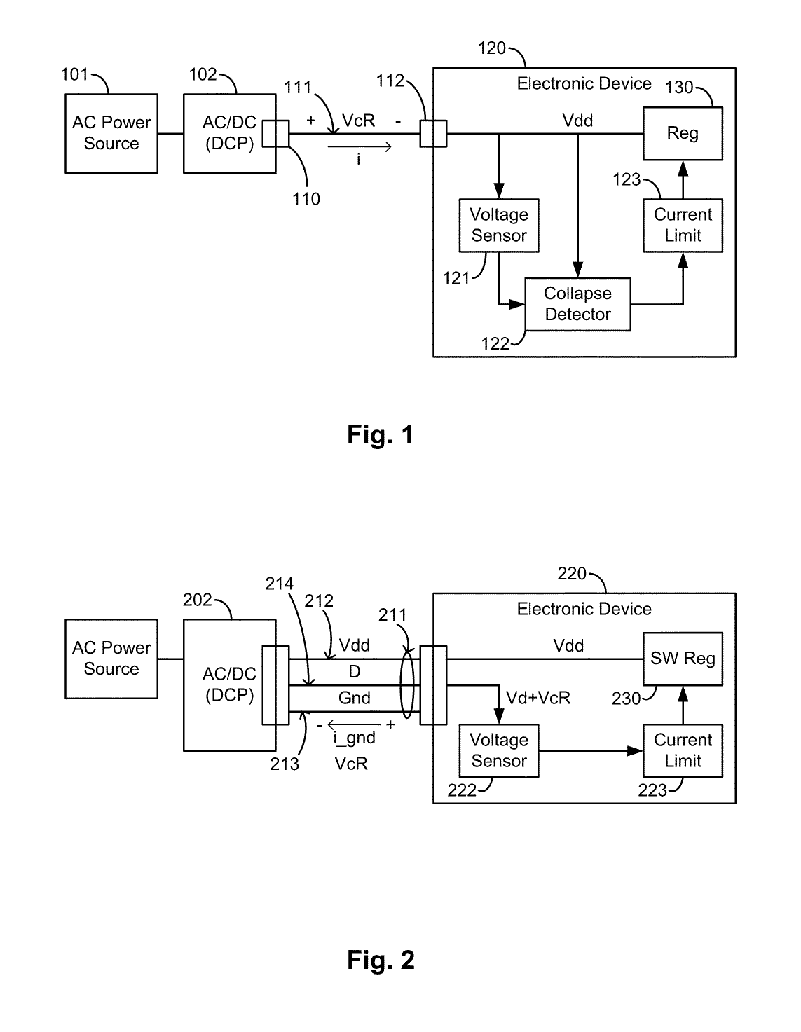

FIG. 1 illustrates a cable resistance compensation circuit according to one embodiment. Electronic device 120 includes a regulator 130, which may be a switching regulator, for example. Regulator 130 has an input coupled to receive power from an external power source such as an AC/DC converter 102 (e.g., a dedicated charge port, “DCP,” or “adapter”). Adapter 102 may be a wall adapter that receives AC power from AC power source 101 (e.g., an electrical outlet or plug) and converts the AC power to DC power for transmission to electronic device 120. Electronic device 120 is coupled to adapter 102 by an electrically conducting cable 111. Cable 111 may have a first connector terminal 110 that plugs into a socket on adapter 102, for example, and a second connector terminal 112 that plugs into a socket on device 120. Cable 111 may have multiple distinct electrical conduction paths (e.g., wires). Only one path is illustrated in FIG. 1 for transmitting a DC supply voltage, Vdd.

During operation, regulator 130 may draw current across cable 111. A current “i” flowing through cable 111 may result in a voltage drop of VcR caused by the resistance of the cable, Rc. Features and advantages of the present disclosure may sense the voltage on the device side of the cable and modify the operating parameters of the circuit to prevent erroneous operation. For example, a current limit circuit 123 may be used to control a maximum current in regulator 130. In one embodiment, current limit circuit 123 may be reconfigured to a plurality of current limit values as part of a process for determining a current sourcing capability of adapter 102. At each current limit value, regulator 130 may draw different levels of current (successively increasing or decreasing). If adapter 102 cannot provide the current, the voltage from adapter 120 Vdd will collapse. Thus, current limit circuit 123 may iteratively increase the current “i” up to a current that causes the input voltage from adapter 102 to collapse to determine the maximum available current from adapter 102. In some embodiments, the current limit circuit 123 may start above the maximum current of adapter 102 and iteratively lower the current until the voltage does not collapse.

Collapse detector 122 has an input coupled to the input voltage of the regulator to detect whether or not the input voltage Vdd from the external power source is below a particular value (a collapse voltage such as 8v on a 9v). If the input voltage Vdd from the external adapter 102 collapses below the value set by the collapse detector 122 at one of current limit values, then the current limit is too high and should be reduced within the current capability of adapter 102. However, as the current limit is increased, current “i” through the cable results in an increase in the voltage drop VcR caused by the cable resistance. If the resistive voltage drop becomes excessively large, due to a poor quality cable with a high resistance, the system may erroneously detect a collapse when in fact the voltage drop is caused by the cable resistance and not excessive current.

Certain embodiments of the present disclosure may change the collapse voltage level used by collapse detector 122 when high resistance cables are detected. For example, in one embodiment, the circuit may sense the input voltage at different current levels and change the collapse voltage level to compensate for the voltage drop caused by a resistance of the cable. For example, voltage sensor 121 may determine a first voltage V1 corresponding to a first input current value i1 and a second voltage V2 corresponding to a second input current value i2. The changes in current and voltage may be used to determine a cable resistance, for example. If the drop in voltage between two current measurements indicates a high cable resistance, which would lead to a larger drop in voltage at the input of regulator 130, then a collapse voltage may be reduced to account for the drop in voltage caused by the cable resistance. In particular, cable resistance is given by Rc=Δv/Δi. Thus, if the voltage changes by more than a particular threshold in response to a change in current (corresponding to a cable resistance above some threshold), then a lower collapse voltage may be used, for example.

FIG. 2 illustrates a cable resistance compensation circuit according to another embodiment. In this example, an electronic device 220 is coupled to an adapter 202 using a cable 211 that includes a power supply connection 212, ground connection 213, and one or more data connections 214. Some applications may require accurate voltages to be transferred between adapter 202 and device 220, for example. However, many cables include both a power supply voltage (Vdd) and ground voltage (Gnd). Because ground is being provided by adapter 202 across cable 211, high currents in the ground path 213, such as i_gnd may cause a voltage drop VcR sometimes referred to as “ground bounce” because the voltage across cable 211 results in the device ground being higher than the adapter ground. When the ground bounce is too high (e.g., under high current), errors may occur in the transfer of voltages on the data lines between the adapter and the device.

In one embodiment, a voltage sense circuit 222 senses the voltage on the data line 214. A high ground bounce causes the data line voltage Vd to increase to Vd+VcR, for example. This voltage may be used to set a maximum current in the system to maintain a ground bounce voltage below a determined value. For example, voltage sensor 222 may determine a first voltage V1 corresponding to a first input current value i1 and a second voltage V2 corresponding to a second input current value i2. The changes in current and voltage may be used to determine a cable resistance, Rc, as described above, for example. Proper operation of the system may set a maximum tolerable ground bounce, Vgb_max, for error free performance. With a known cable resistance and known maximum tolerable ground bounce, a maximum current may be determined as follows: Imax=Vgb_max/Rc. Accordingly, voltage sensor 222 may send one or more signals to current limit 223 to configure a maximum current in regulator 230.

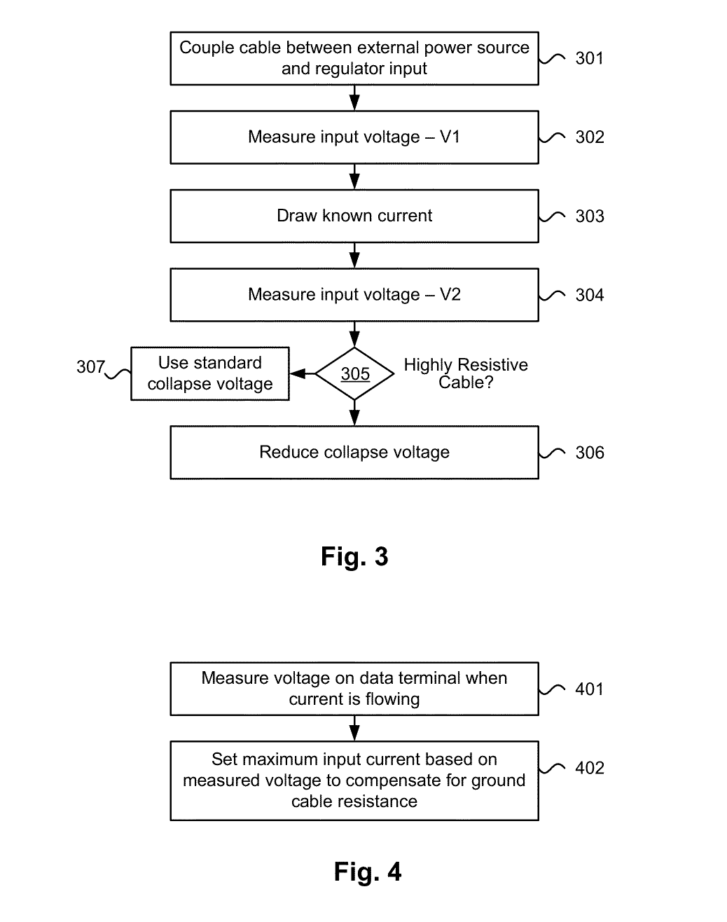

FIG. 3 illustrates a process of compensating for cable resistance according to an embodiment. At 301, a cable is coupled between an external power source and an input of a regulator on an electronic device. At 302, an input voltage V1 is measured. The input voltage may be measured at a power supply terminal of the cable, for example, or at the input of the switching regulator (which may or may not be the same circuit node). In one embodiment, when the cable is connected, a first voltage measurement is taken in a state where the regulator is substantially off and not drawing appreciable current. With essentially no current flowing through the cable, the resistive drop will be practically zero. Accordingly, the first voltage measurement may be taken at zero current. At 303, the regulator may draw a known current (e.g., 500 mA) across the cable. The current may result in a voltage drop due to cable resistance. At 304, a second input voltage V2 is measured. Based on the voltage measurements and known currents, the system may reduce the collapse voltage. For example, if the second voltage measurement indicates a high cable resistance at 305, then the collapse voltage is reduced at 306. However, if a difference between the first and second voltage measurements is less than a threshold, corresponding to a low cable resistance, then a standard collapse voltage is used at 307. While the present example illustrates a process where the first voltage is measured at zero current, other embodiments may measure two voltages with the current on. In some embodiments, the system may calculate the cable resistance as the difference between the voltage measurements divided by the difference between the currents when the voltage measurements were taken, for example.

FIG. 4 illustrates compensation of cable resistance according to another embodiment. According to one example process, a voltage on a data terminal of a cable is measured when current is flowing at 401. For example, referring to the process illustrated in FIG. 3, the regulator may be turned on and a current (e.g., 500 mA) may flow through a power supply terminal of the cable and into the regulator. The return current flowing through a ground terminal of the cable back to the external power source may create a ground bounce that shifts the voltage on the data terminal of the cable. In one embodiment, the voltage on the data terminal may be measured when the current is off and when the current is on (e.g., as in steps 302 and 304 above in FIG. 3), to determine the ground bounce. The maximum input current may be set based on the measured voltage to compensate for ground cable resistance at 402. For example, ground cable resistance may be equal to ground bounce/i_gnd, where i_gnd is the second non-zero current flowing when the second voltage measurement is taken, and where ground bounce is the difference between the data terminal voltage with zero current flowing and the data terminal voltage when a non-zero current (e.g., 500 mA) is flowing.

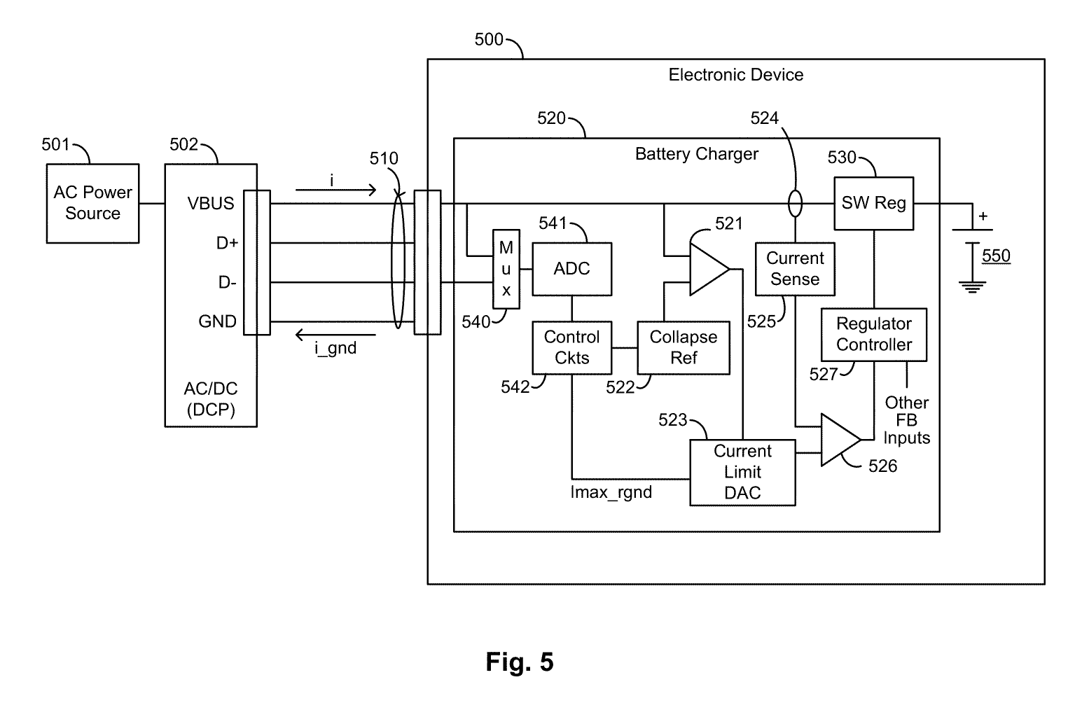

FIG. 5 illustrates another example of cable resistance compensation according to another embodiment. In this example, a battery charger circuit 520 on an electronic device 500 is coupled to an AC power source 501 though a dedicated charge port adapter 502 using a 4-terminal cable 510, such as a serial bus (e.g., USB-type) cable, for example. Cable 510 may include a power supply terminal VBUS, ground terminal GND, and two data terminals D+and D−. When cable 510 is connected between adapter 502 and device 500, power supply voltage VBUS is provided to the input of switching regulator 530 and the ground of the battery charger 520 is coupled to ground of the adapter 502.

Battery charger 520 includes a switching regulator 530 that provides power to a battery 550, for example. Battery 550 may be coupled to other device electronics (not shown) such as a display, data processor, and/or RF transceiver, for example. Switching regulator 530 may include a regulator controller 527 for receiving feedback and turning switches on and off In one embodiment, input current is sensed at 524 (e.g., via a resistor or sense FET) and a current sense circuit 525 provides a signal to one input of a differential circuit 526, such as an amplifier. A second input of circuit 526 is coupled to current limit DAC to set a maximum current. An output of circuit 526 is provided as an input (e.g., a wired OR) to regulator control circuitry 527 so regulator 530 maintains a controlled input current, for example. Regulator control circuitry 527 may receive other feedback inputs as well, such as battery voltages or a sensed output current, for example.

Initially, multiplexer 540 (“MUX”) may selectively couple (i.e., multiplex) VBUS to an input of an analog-to-digital converter (“ADC”) 541 to sense the voltage on VBUS with switching regulator 530 not drawing current. ADC 541 may measure VBUS when the current is approximately zero. At zero current, MUX 540 may further couple the D− terminal to the input of ADC 541 to measure a voltage on D− at zero current.

After the first voltage measurement, switching regulator 530 is turned on and draws current. Switching regulator 530 may initiate an auto-input current limit (AICL) process for successively drawing increasing currents until VBUS collapses to determine a maximum current capability of adapter 502, for example, and setting the current limit below the maximum capacity of the adapter. In one embodiment, an initial current drawn by switching regulator 530 is 500 mA. MUX 540 may be configured to selectively couple (multiplex) VBUS to the input of ADC 541 to measure the voltage on VBUS while the current is flowing. MUX 540 may then be configured to couple the voltage on D− to the input of ADC 541 to measure the voltage on D− while the current is flowing.

In one embodiment, control circuits 542 may include storage registers (or memory) to store the measured voltages described above. Control circuits 542 may process the measured VBUS voltages and reduce a collapse voltage generated by collapse reference 522, for example. In one embodiment, if the change in voltage, and corresponding resistance is greater than a threshold, the cable may be rejected and the process is halted. In another embodiment, control circuits 542 may process the measured D− voltages and produce a signal (e.g., Imax_rgnd) to a current limit digital-to-analog converter (“DAC”) 523 to set a maximum current limit to maintain the ground bounce below a specified value.

Battery charger 520 may continue to successively increase the current drawn from adapter 502 to detect when VBUS falls below a collapse voltage. Battery charger 520 may include a differential comparison circuit 521 (e.g., a comparator or high gain amplifier) having a first input coupled to VBUS and a second input coupled to collapse reference generator 522 to receive a collapse voltage. When VBUS falls below the collapse voltage, comparison circuit 521 signals current limit DAC 523 that a maximum current capability has been reached (current limit DAC may set the current limit as the previous value used before the collapse occurred). However, if the cable resistance causes a large voltage drop, VBUS may fall below the collapse voltage before adapter 502 actually collapses for lack of current capability (i.e., a false collapse may be detected). Therefore, embodiments of the present disclosure may use the measured values of VBUS to detect a high resistance cable, and the collapse voltage may be reduced when a high resistance cable is detected to prevent false collapses from occurring.

Adapter 502 may be capable of providing multiple different voltages to electronic device 500. In one embodiment, adapter 502 initially provides VBUS=5v and D+and D− are short circuited. Next, D− may be coupled to ground with a weak pull down. This ground voltage may be measured on device 500 to check for ground bounce as described above. Thereafter, device 500 may signal adapter 502 to increase the voltage by presenting particular voltage combinations on D+and D− (e.g., D+/D−=V1 for VBUS=12v; D+=V2, D−=V1 for VBUS=9v; D+=V1, D−=V2 for VBUS=20v; and D+=V1, D−=Gnd for VBUS=5v (default), where V1 may be 0.6v and V2 may be 3.3v). Ground bounce may cause the voltages generated on D+ and D− (on the electronic device side) to be offset from the ground of adapter 502. This can potentially lead an adapter to misread the desired voltage and generate the wrong VBUS voltage, potentially damaging either or both of the device 500 or adapter 502, for example.

Advantageously, ground bounce may be limited to a particular specified value (e.g., maximum ground bounce, GBmax, not more than 750 mV). Accordingly, measured voltages on D− when current is off and when current is on may be used to set a maximum current. The ground bounce is the change in voltage sensed on the data terminal between when current is off and when current is on. Thus, cable resistance is:

Rgnd=ground bounce/current.

Once Rgnd is known, Imax can be determined as follows:

Imax=GBmax/Rgnd=750 mV/Rgnd.

Imax may, in turn, set an upper limit on the current limit, so that the AICL process to find a maximum current capability of adapter 502 may be stopped before collapse occurs if the ground bounce Imax is reached. Sensing Rgnd may also be used to prevent ground bounce from causing a problem with the adapter changing its output voltage and/or not being compliant with the HVDCP specification, for example.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A circuit comprising:
a regulator coupled to receive an input voltage and an input current from an external power source across a cable;
a voltage sensor coupled to sense the input voltage;
a collapse detector coupled to detect whether or not the input voltage is below a first value; and
a current limit circuit to control a maximum current in the regulator,
wherein the current limit circuit is reconfigured to a plurality of current limit values and the collapse detector detects if the input voltage from the external power source collapses below the first value at the plurality of current limit values, and
wherein the voltage sensor determines a first voltage corresponding to a first input current value and a second voltage corresponding to a second input current value, and in accordance therewith, reduces the first value to a second value to compensate for a voltage drop caused by a resistance of the cable.

2. The circuit of claim 1 wherein the first input current value is approximately zero.

3. The circuit of claim 1 wherein the voltage sensor is an analog-to-digital converter.

4. The circuit of claim 1 wherein the input voltage is provided on a power supply terminal of the cable, and wherein the voltage sensor is further configured to sense a voltage on a data terminal of the cable when current is flowing through the cable, wherein a measured voltage on the data terminal is used to set a maximum current to maintain a ground bounce voltage below a determined value.

5. The circuit of claim 4 further comprising a multiplexer having a first input coupled to receive the input voltage and a second input coupled to receive the voltage on the data terminal.

6. The circuit of claim 1 wherein the regulator is a switching regulator.

7. The circuit of claim 1 wherein the second value is less than the first value.

8. The circuit of claim 1 wherein the cable is rejected if a difference between the first voltage and second voltage is greater than a threshold.

9. A method comprising:
receiving an input voltage and an input current from an external power source across a cable at an input of a regulator;
reconfigured a current limit circuit to a plurality of current limit values to set a maximum current in the regulator and detecting, at the plurality of current limit values, if the input voltage from the external power source collapses below a first value, and
determining a first voltage corresponding to a first input current value and a second voltage corresponding to a second input current value, and in accordance therewith, changing the first value to a second value to compensate for a voltage drop caused by a resistance of the cable.

10. The method of claim 9 wherein the first input current value is approximately zero.

11. The method of claim 9 wherein determining comprises converting the first voltage and the second voltage to digital values using an analog-to-digital converter.

12. The method of claim 9 wherein the input voltage is provided on a power supply terminal of the cable, the method further comprising determining a voltage on a data terminal of the cable when current is flowing through the cable, wherein a measured voltage on the data terminal is used to set a maximum current to maintain a ground bounce voltage below a determined value.

13. The method of claim 12 further comprising a multiplexing the input voltage and the voltage on the data terminal to a voltage sense circuit.

14. The method of claim 9 wherein the regulator is a switching regulator.

15. The method of claim 9 wherein the second value is less than the first value.

16. The method of claim 9 wherein the cable is rejected if a difference between the first voltage and second voltage is greater than a threshold.
